(19) United States
(12) Patent Application Publication
(10) Pub. No.: US 2008/0064483 A1
(43) Pub. Date: Mar. 13, 2008

(54) SLOT MACHINE

(75) Inventor: Hiro Sakuma, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/852,610

(22) Filed: Sep. 10, 2007

(30) Foreign Application Priority Data
Sep. 11, 2006 (JP) 2006-245127

(51) Int. Cl. A63F 13/00

(52) U.S. Cl. 463/20

(57) ABSTRACT

A slot machine comprising a display; an input device; and a game controller is provided. The display displays a plurality of symbols in symbol display areas arranged in a matrix manner, each symbol display area being capable of containing only one symbol. The game controller operates to cause the display to display symbols in a range positioned on a bottom edge of the display frame at a beginning of the unit game. A group of symbols are displayed in a range positioned on a top edge of the display frame and moved downward. A number of symbols having the same attribute and neighboring with each other are displayed in a connected manner such that an elimination display of the number of symbols is performed if the number exceeds a predetermined number. Then, the payout corresponding to the elimination display is provided.

### CROSS REFERENCE TO RELATED APPLICATIONS

This application is based upon and claims the benefits of priorities from Japanese Patent Application No. 2006-245127 filed on Sep. 11, 2006, the entire contents of which are incorporated herein by reference.

### FIELD OF THE INVENTION

The present invention relates to a slot machine having symbols rearranged on a display and a method of playing a game with the slot machine.

### RELATED ART

In a conventional slot machine, a predetermined number of symbols are rearranged on a display thereof such that a winning combination formed in the rearranged symbols is provided (e.g., U.S. Pat. No. 6,960,133).

In particular, in the case of a scatter symbol, a payout rate corresponding to the winning combination is determined by the number, which is greater than a predetermined number, of scatter symbols in the rearranged symbols displayed on the display. Therefore, it is not necessary that the scatter symbols are aligned on a pay line, but the number of scatter symbols are rearranged on the display in order to obtain the winning combination. However, it may be required that the scatter symbols are aligned and appear from the left or right reel in a series with some slot machine.

That is, the rearrangement of symbols is directly related to the winning combination. Therefore, if a new and innovative relationship between the way of displaying symbols and the payout is created with a hardware with which rearrangement of the symbols is realized, the impression given to the player may be enormous such that it is possible to generate a new entertainment feature with the slot machine.

### SUMMARY OF THE INVENTION

In the present invention, a slot machine and a method of playing a game with the slot machine are provided.

In the slot machine comprising a display; an input device; and a game controller, the display displays a plurality of symbols, each of which has one of a plurality of attributes, in a predetermined number of symbol display areas arranged in a matrix manner to form a display frame, each symbol display area being capable of containing one symbol. The input device may comprise an input device by which a bet number is set for a unit game. The game controller operates to cause the display to display statically a first predetermined number of symbols in a first corresponding number of symbol display areas forming a first predetermined range positioned on a bottom edge of the display frame at a beginning of a unit game. The game controller also operates to cause the display to display a second predetermined number of symbols in a second corresponding number of symbol display areas forming a second predetermined range positioned on a top edge of the display frame wherein the second predetermined number of symbols are moved downward from the top edge through empty symbol display areas positioned below the second predetermined range and above the first predetermined range. The game controller further operates to cause the display to display statically the second predetermined number of symbols in a third corresponding number of symbol display areas forming a third predetermined range after the second predetermined number of symbols are landed on the first predetermined range, which is located just above the third predetermined range. The game controller operates to cause the display to display all symbols having a same attribute in a fourth corresponding number of symbol display areas, each of which neighbors on at least one of four directions: up and down and left and right, in a grouped manner. The game controller operates to cause the display to perform an elimination display of all symbols appearing in the fourth corresponding number of symbol display areas if the fourth corresponding number is at least a predetermined number. Then, the game controller operates to cause a payout corresponding to the elimination display.

Further features of the present invention, its nature, and various advantages will be more apparent from the accompanying drawings and the following description of the preferred embodiment.

### BRIEF DESCRIPTION OF THE DRAWINGS

FIG. 1 is a view illustrating features of a slot machine according to an embodiment of the present invention.

FIG. 2 is a perspective view of the slot machine shown in FIG. 1.

FIG. 3 is a view illustrating contents to be displayed on a lower image display panel.

FIG. 4 shows symbols to be used in a unit game.

FIG. 5 shows a predetermined range of areas on which symbols are displayed statically at the beginning of the unit game.

FIG. 6 shows an example of aligned symbols dropping from the top edge in a symbol display frame at the beginning of the unit game.

FIG. 7 shows another example of aligned symbols dropping from the top edge in a symbol display frame at the beginning of the unit game.

FIG. 8 shows yet another example of aligned symbols dropping from the top edge in a symbol display frame at the beginning of the unit game.

FIG. 9 is a block diagram showing schematically a control system of the slot machine.

FIG. 10 shows a flowchart of a main control program.

FIG. 11 shows a flowchart of a main game process program.

FIG. 12 shows a flowchart of a game lottery process program.

FIG. 13 shows a flowchart of a symbol display control process program.

FIG. 14 is a view illustrating features of a slot machine according to an embodiment of the present invention.

FIG. 15 shows a predetermined range of areas on which symbols are displayed statically at the beginning of the unit game.

FIG. 16 shows an example of vertically aligned symbols dropping from the top edge in a symbol display frame at the beginning of the unit game.

FIG. 17 shows another example of vertically aligned symbols dropping from the top edge in a symbol display frame at the beginning of the unit game.

FIG. 18 shows yet another example of vertically aligned symbols dropping from the top edge in a symbol display frame at the beginning of the unit game.

### DETAILED DESCRIPTION OF THE PREFERRED EMBODIMENT

In the following, embodiments according to the present invention are described with reference to the drawings.

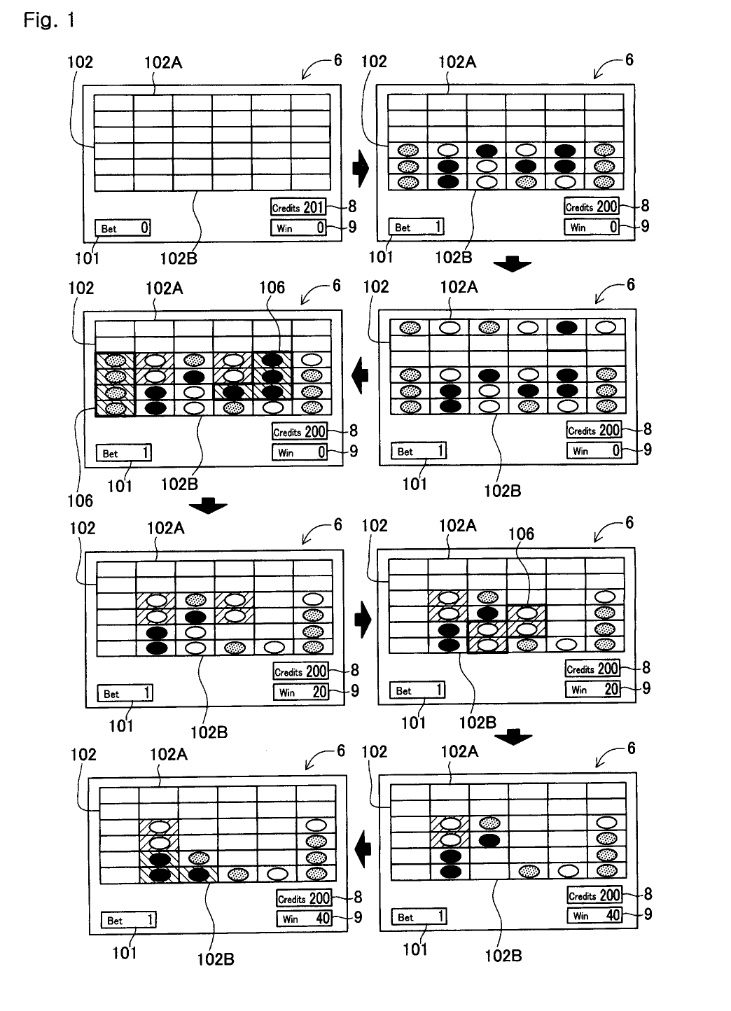

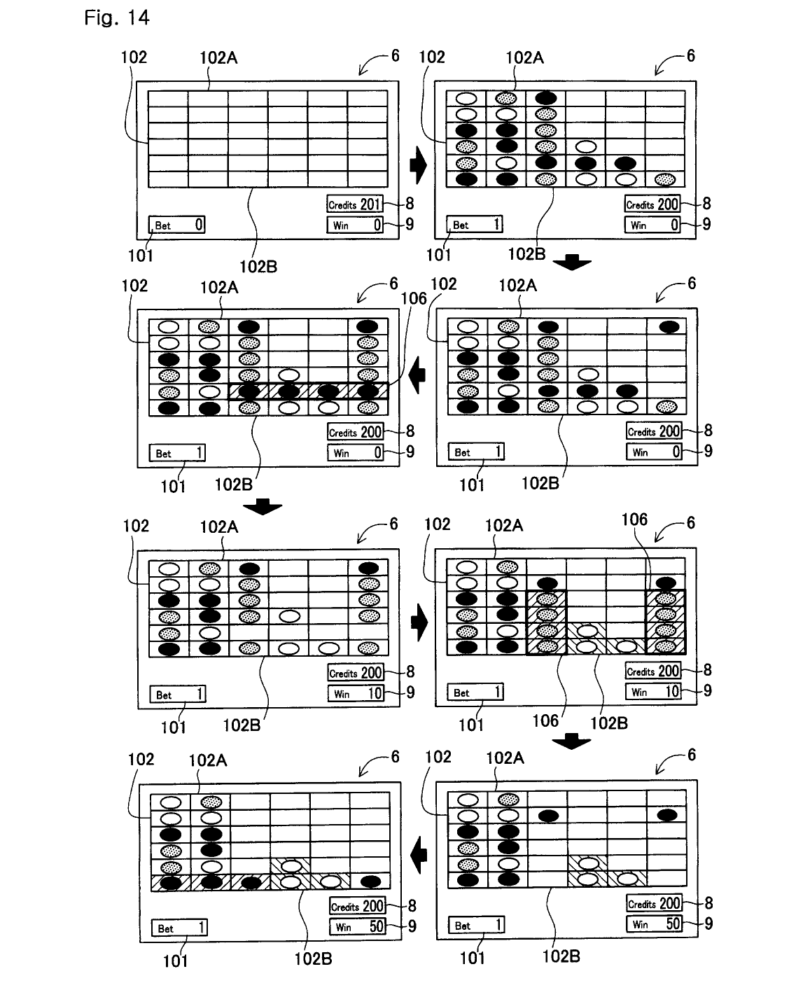

FIG. 1 is a diagram showing features of a slot machine as an embodiment of the present invention. The stage number being counted from the top stage and the right or left position are utilized to specify one of the images displayed in a chronological order on a lower image display panel 6 shown in FIG. 1. The way of illustrating the features is the same as in FIG. 14 to be described later. In the slot machine according to this embodiment of the present embodiment, a symbol display frame 102 comprising: symbol display areas of 6 rows by 6 columns is displayed on the lower image display panel 6 as shown at the left position on the 1st stage in FIG. 1. Further, a BET number display part 101, a credit number display part 8, and a payout number display part 9 are displayed on the lower image display panel 6.

When a unit game is started with a BET number displayed on the BET number display part 101, one symbol is fixedly displayed on each of the symbol display areas of 3 rows by 6 columns which form a predetermined range positioned at the bottom edge 102B of the symbol display frame 102 as indicated in the lower image display panel 6 shown at the right position on the 1st stage in FIG. 1.

One symbol is displayed in each of the symbol display areas of 1 row by 6 columns being positioned at the top edge 102A of the symbol display frame 102 as indicated in the lower image display panel 6 shown at the right position on the 2nd stage in FIG. 1. Then, six symbols aligned in the 1 row by 6 columns are displayed as they are dropping (moving downward) in the symbol display frame 102.

When each symbol having been displayed as being moved downward is eventually displayed as being landed on the predetermined range of symbol display areas of 3 rows by 6 columns in which the symbols are displayed statically as displayed in the lower image display panel 6 shown at the left position on the 2nd stage in FIG. 1. Each dropping symbol is displayed statically in each symbol display area.

Each symbol is displayed in any one of three colors within the symbol display frame 102. The display color of a symbol indicates an attribute of the symbol itself. In this regard, in FIGS. 1 and 14, the kind of pattern filling each symbol stands for the display color (attribute) of each symbol so as to distinguish the display color (attribute) of the symbol.

When the symbols displayed statically in the symbol display areas have the same display color (attribute) as the symbol display areas of the symbols neighbor with each other on at least one of the four directions: up and down and left and right, the symbols displayed in the symbol display areas neighboring with each other are displayed and treated in a connected manner. In this regard, the symbols in a connected state are connectedly displayed by applying texture mapping to backgrounds thereof in the symbol display areas in which the symbols are displayed, as indicated in the lower image display panel 6 shown at the left position on the 2nd stage in FIG. 1.

When four or more symbols are displayed in the corresponding number of symbol display areas neighboring with each other on one of the four directions in the connected manner, an outer frame 106 of a group of the corresponding number of symbol display areas in which the symbols having the same display color (attribute) are displayed is highlighted as indicated in the lower image display panel 6 shown at the left position on the 2nd stage in FIG. 1. Then, an elimination display is performed by removing highlight of the outer frame 106 and each symbol in the outer frame 106 as indicated in the lower image display panel 6 shown from the left position on the 2nd stage to the left position on the 3rd stage in FIG. 1. At this time, a payout corresponding to the elimination display is provided. In this regard, the amount of the provided payout is equal to an amount obtained by multiplying the number of outer frames 106 subjected to the elimination display by a standard amount of payout. More specifically, there are two outer frames 106 subjected to the elimination display on the lower image display panel 6 shown from the left position on the 2nd stage to the left position on the 3rd stage in FIG. 1. Since the standard amount of payout is set to “10” at this moment, a payout amounting to 2×“10”=“20” is provided such that “20” of the amount of payout is displayed in the payout number display part 9 as a payout number. When the payout is provided, the standard amount of payout is doubled.

Subsequently, if there are symbols displayed statically in the symbol display areas located above the symbol display areas subjected to the elimination display of symbols within the symbol display frame 102, the symbols are displayed as they are moved downward (dropping) within the symbol display frame 102 as indicated in the lower image display panel 6 shown from the left position on the 3rd stage to the right position on the 3rd stage in FIG. 1.

The game further progresses in a similar manner as described in the above-mentioned case. That is, when each symbol is displayed as being moved downward and then as being landed on a range of a symbol display area in which a symbol is displayed statically as indicated in the lower image display panel 6 shown on the right position on the 3rd stage in FIG. 1, each landed symbol is displayed statically in the symbol display area. However, here, even when each symbol is displayed as being moved downward and as being landing on the lower edge 102B of the symbol display frame 102, each symbol is displayed statically in the symbol display area.

When the symbols displayed statically in the symbol display areas have the same display color (attribute) and the symbol display areas are neighboring with each other on at least one of the four directions: up and down and left and right, all the symbols displayed in the symbol display areas neighboring with each other are treated as being in a connected state. The symbols in the connected state are connectedly displayed by applying the texture mapping to backgrounds of the symbol display areas in which the symbols are displayed, as indicated on the lower image display panel 6 shown on the right position on the 3rd stage in FIG. 1.

When four or more symbols are displayed in the corresponding number of symbol display areas neighboring with each other on one of the four directions in the connected manner, an outer frame 106 of a group of the corresponding number of symbol display areas in which the symbols having the same display color (attribute) are displayed is highlighted as indicated in the lower image display panel 6 shown at the right position on the 3rd stage in FIG. 1. Then, an elimination display is performed by removing highlight of the outer frame 106 and each symbol in the outer frame 106 as indicated in the lower image display panel 6 shown from the right position on the 3rd stage to the right position on the 4th stage in FIG. 1. At this time, a payout corresponding to the elimination display is provided. In this regard, the amount of the provided payout is equal to an amount obtained by multiplying the number of outer frames 106 subjected to the elimination display by the standard amount of payout. More specifically, there is one outer frame 106 subjected to the elimination display on the lower image display panel 6 shown from the right position on the 3rd stage to the right position on the 4th stage in FIG. 1. Since the standard amount of payout is “20” at this moment, a payout amounting to 1×“20”=“20” is provided such that a numeral (“40”) obtained by adding “20” of the amount of payout to the current payout number is displayed in the payout number display part 9 as the payout number. When the payout is provided, the standard amount of payout is further doubled.

Also subsequently, if there are symbols displayed statically in the symbol display areas located above the symbol display areas subjected to the elimination display of symbols within the symbol display frame 102, the symbols are displayed as they are moved downward (dropping) within the symbol display frame 102. The game further progresses in a similar manner as described in the above-mentioned case.

If there are no symbols displayed in the symbol display areas located above the symbol display areas subjected to the elimination display of symbols within the symbol display frame 102 as indicated in the lower image display panel 6 shown at the left position on the 4th stage in FIG. 1, the unit game terminates at the time.

The number of rows of symbols (that is, the number of symbols) to be displayed as dropping from the top edge 102A of the symbol display frame 102 at the time of the start of the unit game may be changed based on a BET number having been bet for this unit game. In the example shown in FIG. 1, when the BET number is “1”, six symbols aligned in 1 row by 6 columns are displayed as dropping from the top edge 102A of the symbol display frame 102. In this regard, in the present embodiment, when the BET number is “1”, six symbols aligned in 1 row by 6 columns are displayed as dropping from the top edge 102A of the symbol display frame 102. When the BET number is “2”, twelve symbols aligned in 2 rows by 6 columns are displayed as dropping from the top edge 102A of the symbol display frame 102. And when the BET number is “3”, eighteen symbols aligned in 3 rows by 6 columns are displayed as dropping from the top edge 102A of the symbol display frame 102.

In the following, an embodiment in which the present invention is embodied is described in detail with reference to the drawings.

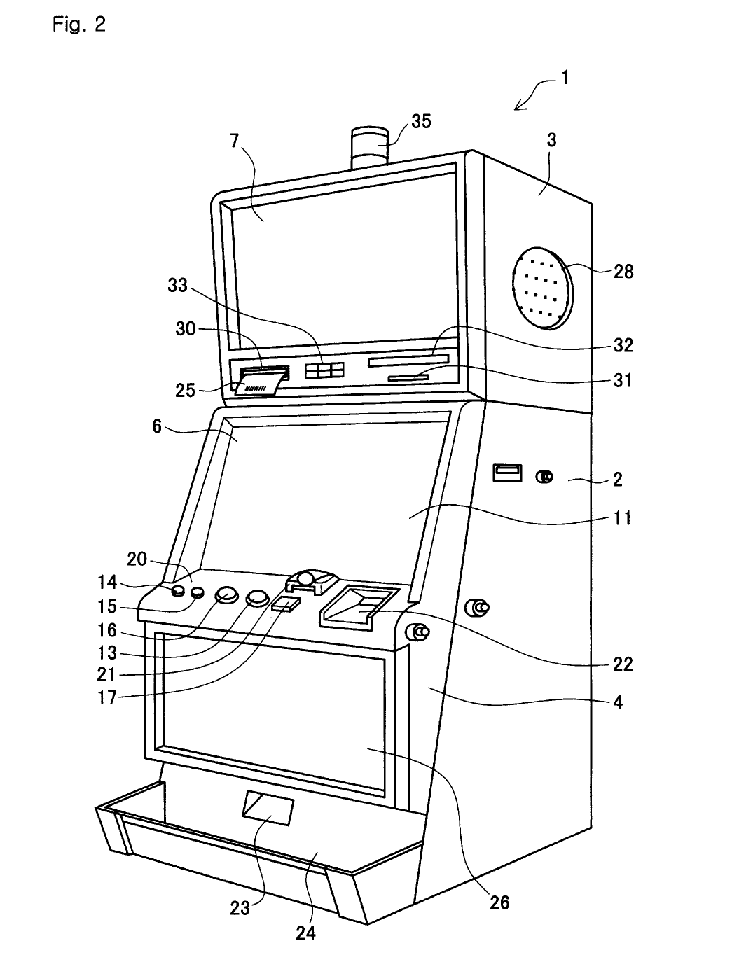

First, a schematic configuration of a slot machine 1 according to the present embodiment is described based on FIG. 2. FIG. 2 is an external perspective view of the slot machine according to the present embodiment of the present embodiment.

The slot machine 1 according to the present embodiment is provided with a cabinet 2, a top box 3 installed on the cabinet 2, and a main door 4 provided on the front face of the cabinet 2.

An upper image display panel 7 is provided on the front face of the top box 3. Here, the upper image display panel 7 is formed of a publicly-known transparent liquid crystal panel, and usually displays information related to the game of the slot machine 1, such as demonstration images and game rules.

On the other hand, a lower image display panel 6 is provided on the front face of the main door 4.

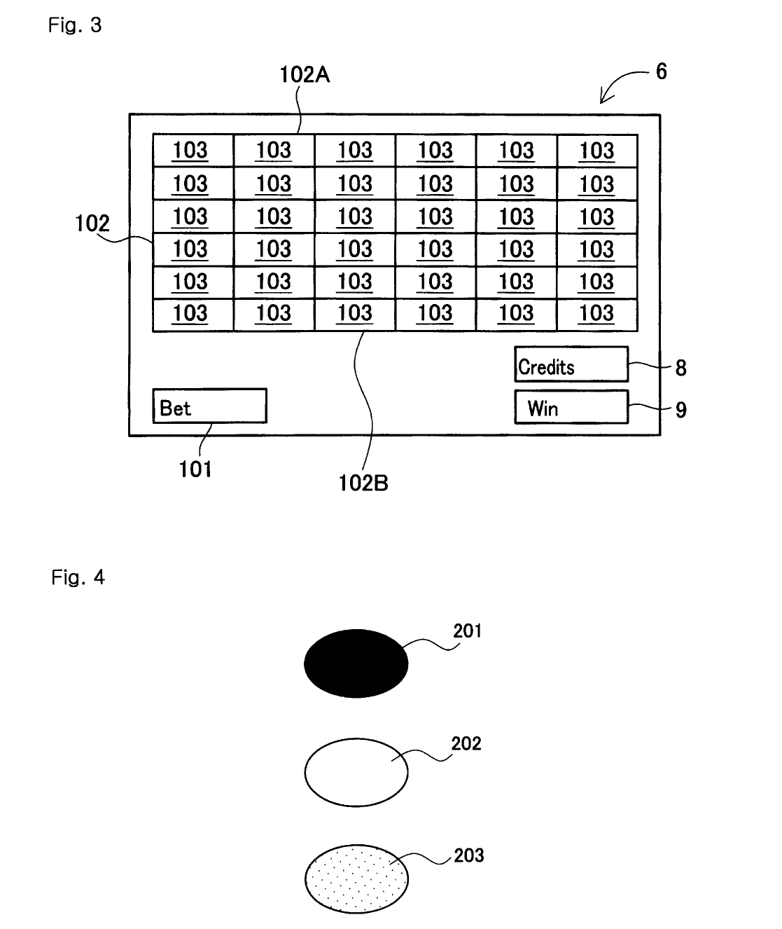

Here, images related to the game of the slot machine 1 and displayed on the lower image display panel 6 are described. FIG. 3 is a diagram showing contents displayed on the lower image display panel 6. In the lower image display panel 6, the symbol display frame 102 comprises thirty six symbol display areas 103 constituting a matrix of 6 rows by 6 columns which are displayed between the top edge 102A and the bottom edge 102B during the unit game as shown in FIG. 3.

The BET number display part 101, the credit number display part 8, and the payout number display part 9 are displayed on the lower image display panel 6. A BET number currently set by a player is displayed in the BET number display part 101. A credit number currently owned by the player is displayed in the credit number display part 8. The amount of payout acquired in the unit game is displayed in the payout number display part 9 as a payout number.

FIG. 4 is a diagram showing the symbols used in the unit game. As shown in FIG. 4, three kinds of symbols 201, 202 and 203 are used in the unit game. Each of the three kinds of symbols 201, 202, and 203 has a different display color. The display color of the symbol indicates the attribute that the symbol has.

In the lower image display panel 6, as shown in FIG. 1, in each of the thirty six symbol display areas 103 of 6 rows by 6 columns forming the symbol display frame 102, any one of symbols 201, 202, and 203 is displayed in each kind of way.

Referring back to FIG. 2, a control panel 20 on which a plurality of buttons through which instructions related to the game progress are input by the player are arranged, a coin receiving opening 21 for receiving a coin being a game medium in the cabinet 2, and a bill validator 22 are provided below the lower image display panel 6.

A spin button 13, a change button 14, a CASHOUT button 15, a 1-BET button 16, and a MAX-BET button 17 are provided on the control panel 20. The spin button 13 is operating means for inputting instructions to start the unit game. The change button 14 is operating means used when the game player asks an attendant in the game hall for exchange of money. The CASHOUT button 15 is operating means for inputting instructions to pay out coins corresponding to credit numbers owned by the player (one credit corresponds to one coin) from a coin payout opening 23 to a coin tray 24, or for inputting instructions to conduct a payout with a bar-coded ticket 25 to be described later.

The 1-BET button 16 is operating means for taking instructions to bet one credit on a game from among the credits owned by the player. The MAX-BET button 17 is operating means for taking instructions to bet the maximum credit number (three credits in the present embodiment) on a game which can be bet on one game from among the credits owned by the player.

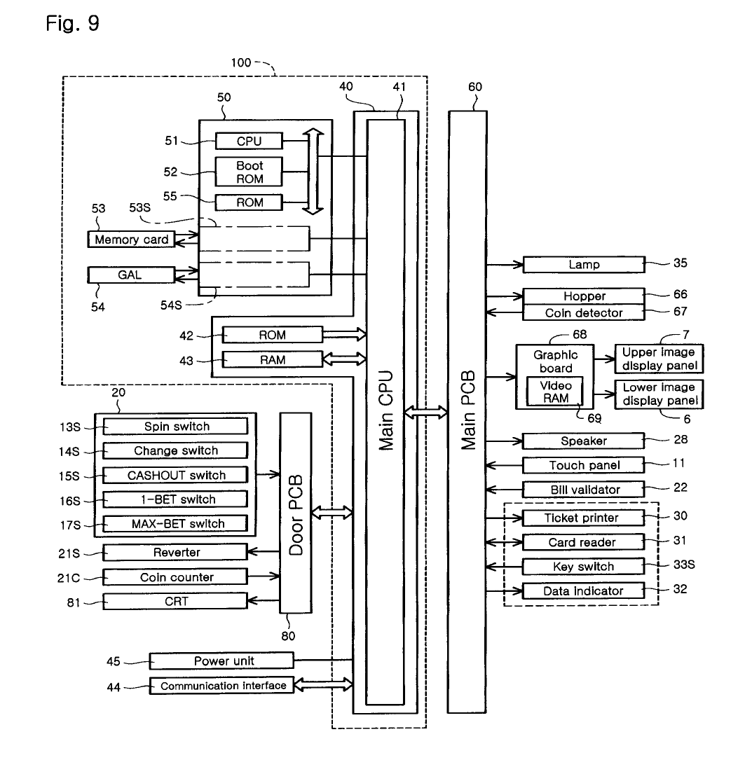

A reverter 21S (refer to FIG. 9) and a coin counter 21C (refer to FIG. 9) are provided in the inside of the coin receiving opening 21. The reverter 21S (refer to FIG. 9) checks the suitability of a coin inserted into the coin receiving opening 21, and objects other than the authentic coin are discharged from the coin payout opening 23. The coin counter 21C (refer to FIG. 9) detects received authentic coins and counts the number of the coins.

The bill validator 22 inspects the suitability of a bill and receives an authentic bill in the cabinet 2. The bill fed into the cabinet 2 is converted into the number of coins, and credits corresponding to the converted number of coins are added as credits owned by the player. The bill validator 22 is configured to be capable of reading the bar-coded ticket 25 to be described later. A belly glass 26 on which characters and the like of the slot machine 1 are drawn is provided on the front face of the lower part of the main door 4, that is, below the control panel 20.

In the slot machine 1 related to the present embodiment, the coin, the bill, or electronic valuable information (credit) corresponding thereto is used as the game medium. However, the game medium applicable to the present invention is not limited thereto, and a medal, a token, electronic money, and a ticket can be used, for example.

A ticket printer 30, a card reader 31, a data indicator 32, and a keypad 33 are provided on the lower part of the upper image display panel 7.

Here, the ticket printer 30 is a printer for printing, on a ticket, a bar code in which data on the credit number, date and time, the identification number of the slot machine 1, and the like are coded, and outputting the ticket as the bar-coded ticket 25. The player can play a game with another game machine by causing the other game machine to read the output bar-coded ticket 25, or can use the bar-coded ticket for a procedure in a prescribed place of the game hall.

The card reader 31 reads data from a smart card and writes data in the smart card. The smart card is a card possessed by the player, and data concerning the history of the games played by the player is stored, for example.

The data indicator 32 comprises a fluorescent display and the like, and displays data read by the card reader 31, and data input by the player via the keypad 33, for example. The keypad 33 is used for inputting instructions and data concerning ticket issuance and the like. A lamp 35 is provided on the top face of the top box 3. The lamp 35 is turned on in a prescribed lighting mode for calling an employee or the like in the game hall when an error occurs in the slot machine 1, and the like.

In addition, a reference numeral 28 indicates a speaker.

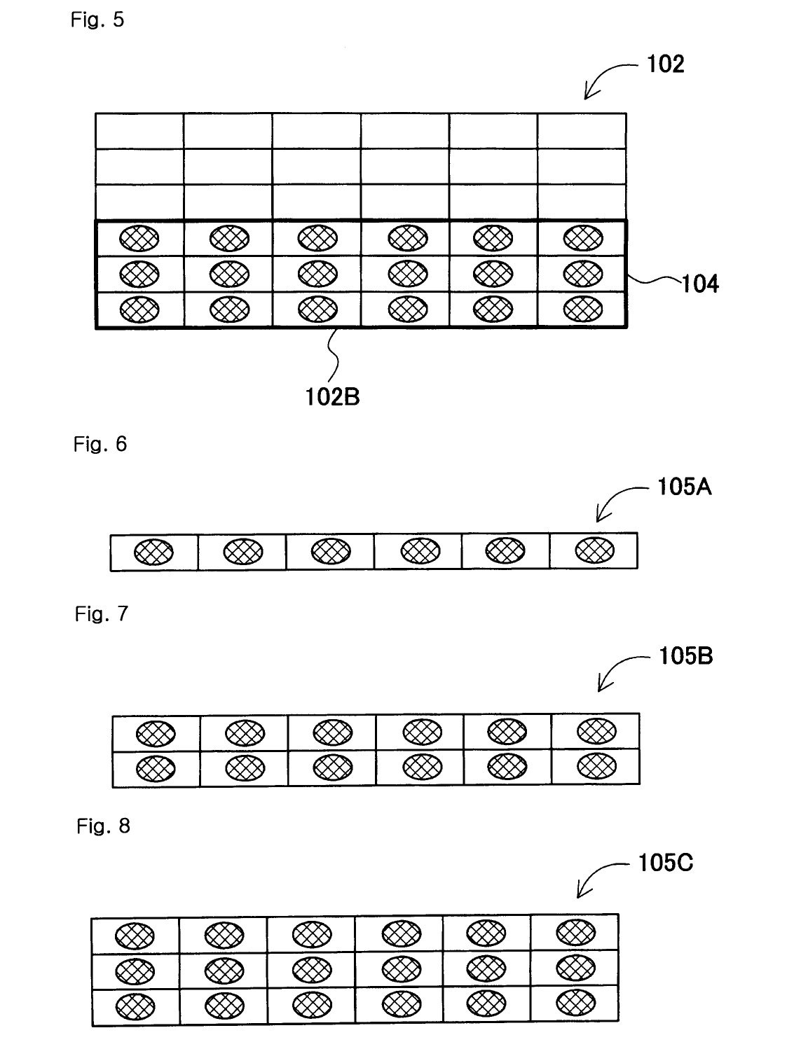

Next, a prescribed area in which the symbols are displayed statically at the time of starting the unit game is described based on FIG. 5. In the lower image display panel 6, as shown in FIG. 5, a prescribed area 104 is constituted of eighteen symbol display areas forming a matrix of 3 rows by 6 columns and is provided on the bottom edge 102B of the symbol display frame 102. Any one symbol of the three kinds of symbols 201, 202, and 203 (refer to FIG. 4) is displayed statically in each of the eighteen symbol display areas which form the prescribed area 104 as indicated in the lower image display panel 6 shown at the right position on the 1st stage in FIG. 1. Although the outer frame of the prescribed area 104 is shown with emphasis in FIG. 5 for convenience of explanation, the outer frame of the prescribed area 104 is not highlighted during the actual game progress.

Next, symbols displayed as dropping from the top edge 102A of the symbol display frame 102 at the time of starting the unit game are described based on FIGS. 6 to 8.

FIG. 6 is a diagram showing a state of symbol alignment to be displayed as dropping from the top edge 102A of the symbol display frame 102 at the time of the start of the unit game for which the BET number is set to “1”. As shown in FIG. 6, at the time of the start of the unit game for which the BET number is set to “1”, a group 105A of six symbols aligned in 1 row by 6 columns is displayed as dropping from the top edge 102A of the symbol display frame 102.

FIG. 7 is a diagram showing a state of symbol alignment to be displayed as dropping from the top edge 102A of the symbol display frame 102 at the time of the start of the unit game for which the BET number is set to “2”. As shown in FIG. 7, at the time of the start of the unit game for which the BET number is set to “2”, a group 105B of twelve symbols aligned in 2 rows by 6 columns is displayed as dropping from the top edge 102A of the symbol display frame 102.

FIG. 8 is a diagram showing a state of symbol alignment to be displayed as dropping from the top edge 102A of the symbol display frame 102 at the time of the start of the unit game for which the BET number is set to “3”. As shown in FIG. 8, at the time of the start of the unit game for which the BET number is set to “3”, a group 105C of eighteen symbols aligned in 3 rows by 6 columns is displayed as dropping from the top edge 102A of the symbol display frame 102.

Next, a configuration related to the control system of the slot machine 1 according to the present embodiment is described based on FIG. 9. FIG. 9 is a block diagram showing schematically the control system of the slot machine 1 according to the present embodiment.

As shown in FIG. 9, the control system of the slot machine 1 basically comprises a mother board 40 and a gaming board 50.

First, the gaming board 50 is described. The gaming board 50 is provided with a CPU 51, a ROM 55, and a boot ROM 52 which are connected to each other via an internal bus. The gaming board 50 is further provided with a card slot 53S corresponding to a memory card 53, and an IC socket 54S corresponding to a GAL (Generic Array Logic) 54.

The memory card 53 comprises a non-volatile memory, and is a recording medium in which a game program and a game system program (hereinafter referred to as the game program and the like) are recorded. The game program recorded in the memory card 53 includes a lottery program. The lottery program is a program for determining the display color (attribute) of each symbol displayed statically in each symbol display area in the prescribed area 104 at the time of starting the unit game, and the display color (attribute) of each symbol is displayed as dropping from the top edge 102A of the symbol display frame 102 at the time of starting the unit game. The lottery program includes symbol weighting data corresponding to each of a plurality of kinds of payout rates (for example, 80%, 84%, 88%).

The payout rate is defined based on payout rate setting data output from the GAL 54, and a lottery is conducted based on the symbol weighting data corresponding to the payout rate.

The card slot 53S is configured so that the memory card 53 can be inserted and removed, and is connected to the mother board 40 via an IDE bus. Therefore, the kind and contents of the game played on the slot machine 1 can be changed by rewriting the game program and the like stored in the memory card 53. It is also possible to change the kind and contents of the game played on the slot machine 1 by replacing the memory card 53 with a memory card 53 storing another game program and the like.

The game program includes image data of game rules, demonstration image data, and the like in addition to a program related to a game progress, image data, and sound data output during the game, and the like.

The GAL 54 is a type of PLD having an OR-fixed type array structure. The GAL 54 is provided with a plurality of input ports and output ports, and, in response to predetermined data input into an input port, outputs data corresponding to the predetermined data from an output port. The data output from this output port is the above-mentioned payout rate setting data.

The IC socket 54S is configured so that the GAL 54 can be attached thereto and detached therefrom, and is connected to the mother board 40 via a PCI bus. Therefore, the payout rate setting data output from the GAL 54 can be changed by rewriting the GAL 54 or replacing the GAL 54 itself.

The CPU 51, the ROM 55, and the boot ROM 52 which are mutually connected via the internal bus are connected to the mother board 40 via a PCI bus. The PCI bus transfers signals between the mother board 40 and the gaming board 50, and supplies electric power from the mother board 40 to the gaming board 50. The ROM 55 stores country identification information and an authentication program. The boot ROM 52 stores a preliminary authentication program, a program (boot code) for the CPU 51 to activate the preliminary authentication program, and the like.

The authentication program is a program for authenticating the game program and the like (alteration check program). The authentication program is described according to the procedure of the alteration check of the game program and the like covered by authentication loading processing. The preliminary authentication program is a program for authenticating the authentication program mentioned above, and is described according to the procedure of the alteration check of the authentication program covered by authentication process.

Next, the mother board 40 is described. The mother board 40 is formed using a commercially available general-purpose mother board (printed circuit board mounted with basic components of a personal computer), and provided with a main CPU 41, a ROM 42, and a RAM 43.

The ROM 42 comprises a memory device, such as a flash memory, and stores permanent data including programs such as a BIOS executed by the main CPU 41, and a lottery table. When the BIOS is executed by the main CPU 41, initialization process is applied to prescribed peripheral devices, and the loading process of the game program and the like stored in the memory card 53 is started via the gaming board 50.

The RAM 43 stores data and a program used when the main CPU 41 operates. Further, the RAM 43 can store various programs such as the authentication program and the game program and the like read via the gaming board 50, and varieties of information such as a credit number currently owned by the player.

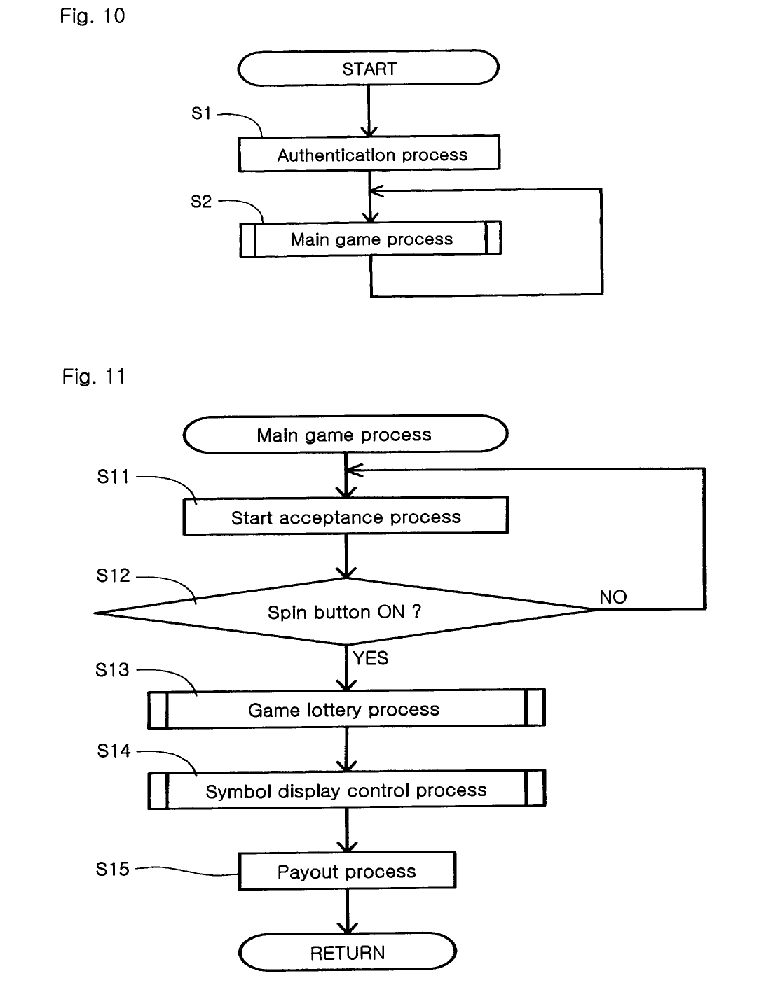

A communication interface 44 is connected to the mother board 40. The communication interface 44 is a communication device for performing communications with a server and the like installed in the game hall via a communication line. The slot machine 1 communicates with the server and the like via the communication interface 44 concerning BET information and the like in the main game process (refer to S2 in FIG. 10) to be described later.

A main body PCB 60 and a door PCB 80 to be described later are connected to the mother board 40 via USBs, respectively. Further, a power supply unit 45 is connected to the mother board 40. When the power is supplied from the power supply unit 45 to the mother board 40, the main CPU 41 of the mother board 40 is activated. Further, the power is supplied to the gaming board 50 via the PCI bus, and the CPU 51 is activated.

A game controller 100 is configured with the mother board 40 and the gaming board 50.

On the other hand, instruments and devices for generating input signals for the game controller 100 and instruments and devices, operations of which are controlled by control signals from the game controller 100, are connected to the main body PCB 60 and the door PCB 80. The game controller 100 executes the game program and the like stored in the RAM 43 based on an input signal input into the game controller 100. Then, the game controller 100 executes predetermined arithmetic processing, stores the computational results in the RAM 43, and executes control process for each instrument and device.

The lamp 35, a hopper 66, a coin detection part 67, a graphic board 68, a speaker 28, a touch panel 11, the bill validator 22, the ticket printer 30, the card reader 31, a key switch 33S, and the data indicator 32 are connected to the main body PCB 60.

Here, the touch panel 11 is arranged on the front face of the lower image display panel 6, and specifies the coordinate position of a portion touched by the player. Based on the specified coordinate position information, it can be determined where the player touches and in which direction the touched part moves.

The hopper 66 is installed in the cabinet 2 and pays a predetermined number of coins out of the coin payout opening 23 to the coin tray 24 based on a control signal from the game controller 100. The coin detection part 67 is arranged inside the coin payout opening 23, and outputs an input signal to the game controller 100 when detecting the payout of the predetermined number of coins from the coin payout opening 23.

The graphic board 68 controls image display in the upper image display panel 7 and the lower image display panel 6 based on control signals from the game controller 100. For example, the credit number owned by the player and stored in the RAM 43 is displayed in the credit number display part 8. The number of credits to be paid out is displayed on the payout number display part 9. The BET number set by the player is displayed in the BET number display part 101.

Here, the graphic board 68 is provided with a VDP (Video Display Processor) for generating image data based on a control signal from the game controller 100, a video RAM 69 for temporarily storing the image data generated by the VDP, and the like. Image data used when the VDP generates the image data is included in the game program.

The graphic board 68 also executes display control in the lower image display panel 6 (refer to FIGS. 1 and 14) based on a control signal from the game controller 100.

The bill validator 22 checks the suitability of a bill and a bar-coded ticket 25 and accepts the authentic bill and bar-coded ticket 25 in the cabinet 2. When receiving the authentic bill, the bill validator 22 outputs an input signal to the game controller 100 based on an amount of the bill. The bill validator 22 also outputs an input signal to the game controller 100 based on the number of coins recorded in the authentic bar-coded ticket 25.

The ticket printer 30 prints, on a ticket, a bar code in which data such as the credit number stored in the RAM 43 is coded based on a control signal output from the game controller 100, and outputs the ticket as a bar-coded ticket 25.

The card reader 31 reads data from a smart card to transmit the data to the game controller 100, or writes data in the smart card based on a control signal from the game controller 100. The key switch 33S is provided in the keypad 33 and outputs a predetermined input signal to the game controller 100 when the keypad 33 is operated by the player. The data indicator 32 displays the data read by the card reader 31 and data input by the player via the keypad 33 based on a control signal output from the game controller 100.

On the other hand, the control panel 20, the reverter 21S, the coin counter 21C, and a cold cathode tube 81 are connected to the door PCB 80. A spin switch 13S corresponding to the spin button 13, a change switch 14S corresponding to the change button 14, a CASHOUT switch 15S corresponding to the CASHOUT button 15, a 1-BET switch 16S corresponding to the 1-BET button 16, and a MAX-BET switch 17S corresponding to the MAX-BET button 17 are provided in the control panel 20. Each switch outputs an input signal to the game controller 100 when a corresponding button is operated by the player.

The coin counter 21C is provided in the inside of the coin receiving opening 21, and checks the suitability of a coin inserted into the coin receiving opening 21 by the player. The coin counter 21C discharges objects other than the authentic coin from the coin payout opening 23, and outputs an input signal to the game controller 100 when detecting the authentic coin.

The reverter 21S operates based on a control signal output from the game controller 100, and distributes coins recognized as the authentic coins by the coin counter 21C to a cashbox (not illustrated) or the hopper 66 installed in the slot machine 1. The cold cathode tube (CRT) 81 is installed in the rear side of the lower image display panel 6 and the upper image display panel 7, lit based on a control signal from the game controller 100, and functions as backlight.

Next, a main control program executed in the slot machine 1 related to the present embodiment is described in detail with reference to the drawings. FIG. 10 shows a flowchart of the main control program.

In the slot machine 1, the memory card 53 is assumed to be already inserted into the card slot 53S of the gaming board 50, and the GAL 54 is assumed to be attached to the IC socket 54S.

First, when an electric power switch is turned on in the power supply unit 45 (application of power), a game controller 100 is activated to execute authentication read process of step (hereinafter abbreviated as S) 1. In the authentication read process, the mother board 40 and the gaming board 50 which form the game controller 100 execute separate processing in parallel.

That is, in the gaming board 50, the CPU 51 reads the preliminary authentication program stored in the boot ROM 52, and executes preliminary authentication of confirming and proving that the authentication program is not altered in advance before loading into the mother board 40 in accordance with the read preliminary authentication program.

On the other hand, in the mother board 40, the main CPU 41 executes the BIOS stored in the ROM 42, and decompresses compressed data built in the BIOS into the RAM 43 to execute a BIOS decompressed into the RAM 43, and diagnoses and initializes various peripheral devices.

Subsequently, the game controller 100 reads an authentication program stored in the ROM 55 to perform authentication of confirming and proving that the game program stored in the memory card 53 inserted in the card slot 53S is not altered. After the authentication process terminates normally, the game controller 100 writes the game program and the like subjected to the authentication (authenticated) in the RAM 43, and acquires the payout rate setting data and the country identification information.

After performing the above-mentioned process, the game controller 100 finishes the authentication read processing.

In S2, the game controller 100 sequentially reads and executes the game program and the like authenticated in the authentication read process of S1 from the RAM 43 to execute the main game process. When the main game process is executed, the game in the slot machine 1 according to the present embodiment is played. Then, the main game process is repeatedly executed while the electric power is supplied to the slot machine 1.

Next, the sub-process of the main game process in S2 is described based on FIG. 11. FIG. 11 is a flowchart of the main game process program in the slot machine 1 according to the present embodiment. Each program shown in the flowchart of FIG. 11 is stored in the ROM 42 or the RAM 43 provided in the slot machine 1, and executed by the game controller 100.

First, in S11 as shown in FIG. 11, the game controller 100 performs a predetermined initial setting, and then executes start acceptance process of setting the insertion of coins, the BET number, and the like. At this time, in the start acceptance process, the player performs the insertion of coins and a bet operation using the 1-BET button 16 and the MAX-BET button 17.

Next, in S12, the game controller 100 determines whether or not the spin button 13 is pressed. Whether or not the spin button 13 is pressed is determined based on whether or not an input signal is received from the spin switch 13S.

When the spin button 13 is not pressed (S12: NO), the game controller 100 returns to the start acceptance process (S11) again. The operation of the correction of the BET number and the like is enabled at this time. On the other hand, when the spin button 13 is pressed (S12: YES), the BET number set based on the operation of the 1-BET button 16 and the MAX-BET button 17 is subtracted from the credit number owned by the player, and the resultant data is stored in the RAM 43 as BET information.

Further, the game controller 100 displays the BET number and the credit number in the BET information in the BET number display part 101 and the credit number display part 8 by transmitting a control signal to the graphic board 68.

On and after S13, the game controller 100 executes the unit game process.

First, in S13, the game controller 100 executes a game lottery process.

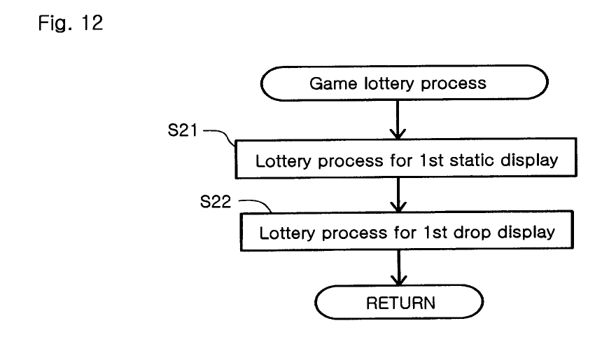

The sub-process of the game lottery process in S13 is described based on FIG. 12. FIG. 12 is a flowchart of a game lottery process program in the slot machine 1 according to the present embodiment. Each program shown in the flowchart of FIG. 12 is stored in the ROM 42 or the RAM 43 provided in the slot machine 1, and executed by the game controller 100.

First, in S21 as shown in FIG. 12, the game controller 100 executes a lottery process for a first static display. In the lottery process, the display color (attribute) of each symbol displayed statically in each symbol display area within the prescribed area 104 at the time of starting the unit game is determined.

Specifically, a plurality of color patterns in which the display color (attribute) of each symbol displayed statically in each symbol display area within the prescribed area 104 is set in advance are read from the game program. On the other hand, one random number value is selected from a numeric value range of “0 to 255” by executing a random number generation program included in the lottery program stored in the RAM 43. Then, a color pattern is determined with reference to the symbol weighting data corresponding to the payout rate setting data and based on the selected random number value. Then, after storing the determined color pattern in the RAM 43, the process shifts to S22.

Next, in S22, the game controller 100 executes a lottery process for a first drop display. In the lottery process, the display color (attribute) of each symbol to be displayed as dropping from the top edge 102A of the symbol display frame 102 at the time of starting the unit game is determined according to the BET number.

Specifically, a plurality of color patterns in which the display color (attribute) of each symbol to be displayed as dropping from the top edge 102A of the symbol display frame 102 at the time of starting the unit game is set in advance are read from the game program. Then, a range of color patterns which can be determined in S22 from the plurality of color patterns is limited based on the BET information stored in the RAM 43 in S12. For example, when the BET number set for the unit game is “1”, the range is limited to a color pattern corresponding to the group 105A (refer to FIG. 6) having six symbols aligned in 1 row by 6 columns. When the BET number set for the unit game is “2”, the range is limited to a color pattern corresponding to the group 105B (refer to FIG. 7) having twelve symbols aligned in 2 rows by 6 columns. When the BET number set for the unit game is “3”, the range is limited to a color scheme pattern corresponding to the group 105C (refer to FIG. 8) having eighteen symbols aligned in 3 rows by 6 columns. On the other hand, one random number value is selected from a numeric value range of “0 to 255” by executing the random number generation program included in the lottery program stored in the RAM 43. Then, a color pattern is determined from the color patterns which are in the limited range with reference to the symbol weighting data corresponding to the payout rate setting data and based on the selected one random number value.

Then, after storing the determined color pattern in the RAM 43, the game controller 100 returns to the main game process of FIG. 11.

Next, returning to the main game processing of FIG. 11 and proceeding to S14, the game controller 100 executes symbol display control processing.

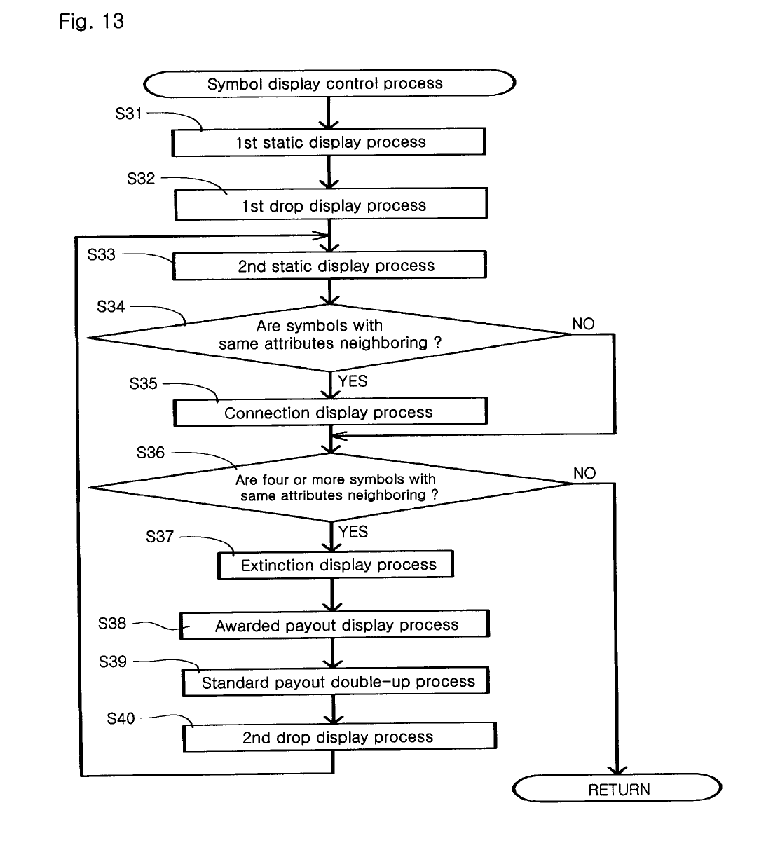

The sub-process of the symbol display control process in S14 is described based on FIG. 13. FIG. 13 is a flowchart of a symbol display control process program in the slot machine 1 according to the present embodiment. Each program shown in the flowchart of FIG. 13 is stored in the ROM 42 or the RAM 43 provided in the slot machine 1, and executed by the game controller 100.

First, as shown in FIG. 13, the game controller 100 performs a first static display process in S31. This process is processing of displaying statically one symbol, in the color pattern determined in the lottery process for the first static display (S21), in each of the eighteen symbol display areas 103 of 3 rows by 6 columns which form the prescribed area 104 within the symbol display frame 102 in the lower image display panel 6 (for example, refer to the right position on the 1st stage in FIG. 1). This process is processing performed between the game controller 100 and the graphic board 68.

Further, in this process, the game controller 100 stores the arrangement situation of symbols within the symbol display frame 102 (The display color (attribute) of each symbol is also included. The same applies in the following) in the RAM 43 as arrangement information.

Then, in S32, the game controller 100 executes a first drop display process. This process is processing of performing the drop display of a plurality of symbols aligned in the color pattern determined in the lottery process for the first drop display (S22) by moving the plurality of symbols within the symbol display frame 102 downward from the top edge 102A of the symbol display frame 102 in the lower image display panel 6 (for example, refer to FIG. 1 from the right position on the 2nd stage to the left position on the 2nd stage). This process is processing executed between the game controller 100 and the graphic board 68.

Further, in this process, the game controller 100 updates the arrangement information stored in the RAM 43 based on the arrangement situation of the symbols within the symbol display frame 102.

Then, in S33, the game controller 100 executes a second static display process. This process is processing of, when the symbols during the drop display are displayed within the symbol display frame 102 of the lower image display panel 6 as the dropping symbols are landing on a range of a symbol display area in which a symbol is displayed statically or on the bottom edge 102B of the symbol display frame 102, and the symbols are displayed statically in the respective symbol display areas (for example, refer to the left position on the 2nd stage in FIG. 1, the right position on the 3rd stage in FIG. 1, or the left position on the 4th stage in FIG. 1). This process is processing executed between the game controller 100 and the graphic board 68.

Further, in this process, the game controller 100 updates the arrangement information stored in the RAM 43 based on the arrangement situation of the symbols within the symbol display frame 102.

In S34, the game controller 100 determines whether or not the symbols statically displayed after the landing display are adjacent to symbols having the same attribute (display color) as the attribute (display color) of the symbols concerned in any one of the four directions vertically and horizontally within the symbol display frame 102 of the lower image display panel 6. The determination is made based on the arrangement information in the RAM 43 updated in S33. Here, when it is determined that the symbols statically displayed after the landing display are not adjacent to the symbols having the same attribute (display color) as the attribute (display color) of the symbols concerned (S34: NO), the game controller 100 proceeds to S36 to be described later. On the other hand, when it is determined that the symbols statically displayed after the landing display are adjacent to the symbols having the same attribute (display color) as the attribute (display color) of the symbols concerned (S34: YES), the game controller 100 proceeds to S35.

In S35, the game controller 100 executes connection display process. This process is processing of applying the texture mapping to a background in the symbol display area in which each symbol determined in S34 to be adjacent to a symbol of the same attribute within the symbol display frame 102 of the lower image display panel 6 is displayed (for example, refer to the left position on the 2nd stage in FIG. 1, or the right position on the 3rd stage in FIG. 1). This process is processing executed between the game controller 100 and the graphic board 68.

Further, in this process, the game controller 100 adds, to the arrangement information stored in the RAM 43, connection information which indicates that each symbol determined to be adjacent to a symbol of the same attribute in S34 is treated as being in a connected state.

In S36, the game controller 100 determines whether or not four or more symbols having the same attribute (display color) are displayed in symbol display areas neighboring with each other within the symbol display frame 102 of the lower image display panel 6. The determination is made based on the connection information added to the arrangement information in the RAM 43 in S35, and the like. Here, when it is determined that four or more symbols having the same attribute (display color) are not in respective symbol display areas neighboring with each other (S36: NO), the game controller 100 returns to the main game process in FIG. 11. On the other hand, when it is determined that four or more symbols having the same attribute (display color) are in respective symbol display areas neighboring with each other (S36: YES), the game controller 100 proceeds to S37.

In S37, the game controller 100 executes an elimination display process. First in this process, the outer frame 106 of a group formed by the symbol display areas in which the four or more symbols of the same attribute are determined in S36 to neighbor to each other are displayed is highlighted within the symbol display frame 102 of the lower image display panel 6 (for example, refer to the left position on the 2nd stage in FIG. 1, or the right position on the 3rd stage in FIG. 1). Further, in this process, the elimination display is performed within the symbol display frame 102 of the lower image display panel 6 after the highlighting, wherein the display of each symbol of the four or more symbols determined in S36 to neighbor to each other is removed along with the outer frame 106 (for example, refer to from the left position on the 2nd stage to the left position on the 3rd stage in FIG. 1, or from the right side of the 3rd stage to the right side of the 4th stage in FIG. 1). This process is processing executed between the game controller 100 and the graphic board 68.

In this process, the game controller 100 updates the arrangement information stored in the RAM 43 based on the arrangement situation of the symbols within the symbol display frame 102.

In S38, the game controller 100 executes an awarded payout display process. This process is processing of adding an amount obtained by multiplying the number of outer frames 106 removed in S39 by the standard amount of payout to the current payout number, and displaying a numeral after the addition on the payout number display part 9 (for example, refer to from the left position on the 2nd stage to the left position on the 3rd stage in FIG. 1, or from the right position on the 3rd stage to the right position on the 4th stage in FIG. 1). This process is processing executed between the game controller 100 and the graphic board 68.

Further, in this process, the game controller 100 stores the numeral displayed in the payout number display part 9 in the RAM 43 as payout information or updates the RAM 43.

Then, in S39, game controller 100 executes a standard payout double-up process. This process is processing of doubling up the standard amount of payout used in S38. Further, in this process, the game controller 100 updates the standard amount of payout stored in the RAM 43 to the standard amount of payout doubled here.

The standard amount of payout at the time of the unit game start is initialized to “10” in S12.

In S40, the game controller 100 executes a second drop display process. In this process, when there are symbols statically displayed in the symbol display areas located above the symbol display areas in which the elimination display of symbols is performed in S37, the drop display is performed by moving the symbols downward within the symbol display frame 102 of the lower image display panel 6 (for example, refer to from the left position on the 3rd stage to the right position on the 3rd stage in FIG. 1, or from the right position on the 4th stage to the left position on the 4th stage in FIG. 1). At this time, when the game controller 100 recognizes that there are symbols to be treated as being in a connected state among the symbols subjected to the drop display according to the connection information added to the arrangement information in the RAM 43, the game controller 100 performs the drop display of each symbol being in the connected state by integrally moving each symbol downward. This process is processing executed between the game controller 100 and the graphic board 68.

Further, in this process, the game controller 100 updates the arrangement information stored in the RAM 43 based on the arrangement situation of the symbols within the symbol display frame 102.

Subsequently, the game controller 100 returns to S33 and repeats each process on and after S33. Then, proceeding to S36, when the game controller 100 determines that four or more symbols having the same attribute (display color) are not in the state of neighboring with each other (S36: NO), the game controller 100 returns to the main game process in FIG. 11.

Returning to the main game process in FIG. 11, the game controller 100 executes the payout process in S15. In this payout process, the payout amount obtained in the unit game (amount which is the numeral displayed in the payout number display part 9, and shown in the numeral of the payout information stored or updated in the RAM 43) is paid out to the player. At this time, the game controller 100 causes the credit number display part 8 to add the numeral displayed in the payout number display part 9 and display the sum by transmitting a control signal to the graphic board 68, while causing the payout number display part 9 to display “0”.

Further, in this payout process, it is also possible to pay out coins corresponding to the credit number (one credit corresponds to one coin) by pressing the CASHOUT button 15, and it is also possible to pay out the bar-coded ticket 25.

Subsequently, the main game process is executed again.

In addition, the present invention is not limited to the above embodiment, and various modifications may be made in the range without departing from the scope of the present invention.

For example, as shown in FIG. 14, symbols subjected to the drop display from the top edge 102A of the symbol display frame 102 at the time of starting the unit game may be five symbols aligned in 5 rows by 1 column.

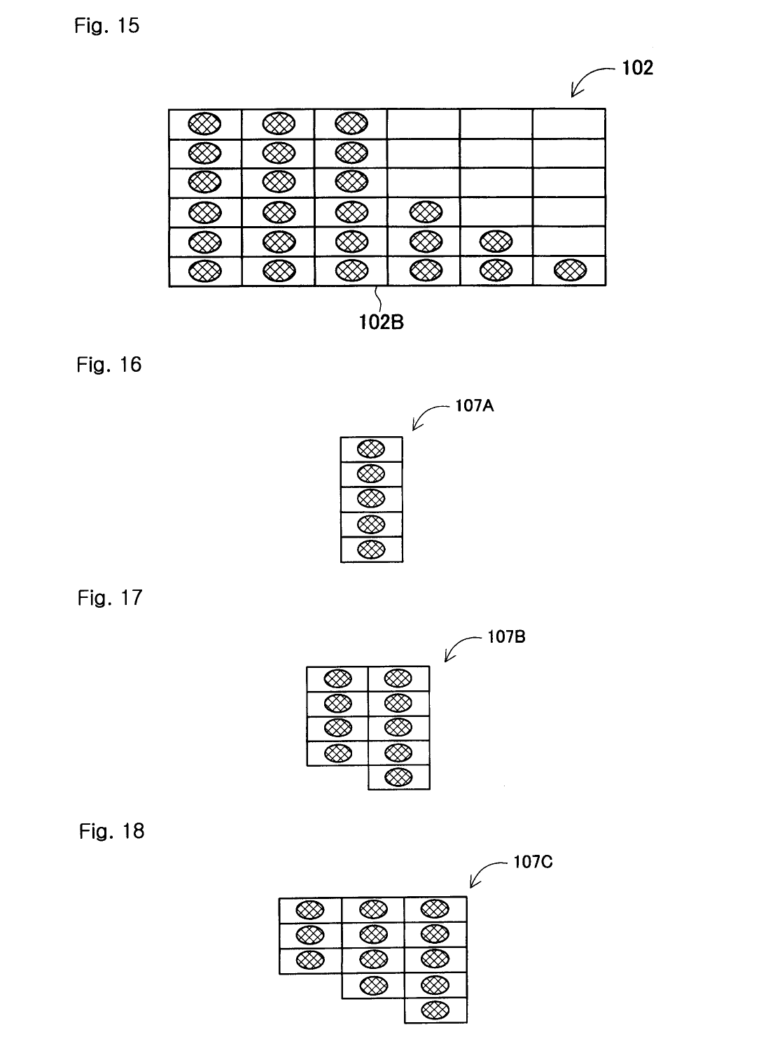

For that purpose, when the unit game is started with the BET number displayed on the BET number display part 101, one symbol is statically displayed in each symbol display area which forms the prescribed area being in contact with the bottom edge 102B of the symbol display frame 102 as indicated in the lower image display panel 6 shown on the right position on the 1st stage in FIG. 14. In this regard, in FIG. 15, each symbol display area in which an elliptical symbol is displayed shows one example of the prescribed area being contact with the bottom edge 102B of the symbol display frame 102.

As indicated in the lower image display panel 6 shown at the right position on the 2nd stage in FIG. 14, the lowermost symbol among five symbols aligned in 5 rows by 1 column is displayed in the rightmost side of the symbol display area being in contact with the upper edge 102A of the symbol display frame 102. Then, the drop display of the five symbols aligned in 5 rows by 1 column is performed by moving the five symbols downward within the symbol display frame 102.

Then, as indicated in the lower image display panel 6 shown at the left position on the 2nd stage in FIG. 14, when each of the symbols subjected to the drop display is displayed as it is landing on the statically displayed symbol, each symbol is statically displayed in the symbol display area subjected to the landing display.

At this time, when the symbols subjected to the fixed display in the symbol display area are of the same display color (attribute) and are in a state of being adjacent to each other in any one of the four directions vertically and horizontally, all the symbols displayed in the symbol display areas are treated as being in a connected state. In this regard, the symbols being in the connected state are connectedly displayed by applying the texture mapping to backgrounds in the symbol display areas in which the symbols are displayed as indicated in the lower image display panel 6 shown at the left position on the 2nd stage in FIG. 14.

When four or more symbols having the same color combination (attribute) are displayed in the corresponding number of symbol display areas neighboring with each other, the outer frame 106 of a group formed by the corresponding number of symbol display areas is highlighted as indicated in the lower image display panel 6 shown from the left position on the 2nd stage to the left position on the 3rd stage in FIG. 14. Then, the elimination display of removing the outer frame 106 and each symbol in the outer frame 106 is performed as indicated in the lower image display panel 6 shown from the left position on the 2nd stage to the left position on the 3rd stage in FIG. 14. At this time, the payout for the elimination display is provided. In this regard, the amount of the provided payout is the amount obtained by multiplying the number of outer frames 106 subjected to the elimination display by the standard amount of payout. More specifically, there is one outer frame 106 subjected to the elimination display in the lower image display panel 6 shown from the left position on the 2nd stage to the left position on the 3rd stage in FIG. 14. Since the standard amount of payout is set to “10” at this moment, a payout amounting to 1×“10”=“10” is provided, and the amount of payout “10” is displayed in the payout number display part 9 as a payout number. In addition, when the payout is provided, the standard amount of payout is doubled.

Subsequently, as indicated in the lower image display panel 6 shown from the left position on the 3rd stage to the right position on the 3rd stage in FIG. 14, if there are symbols statically displayed in symbol display areas located above the symbol display areas subjected to the elimination display of symbols within the symbol display frame 102, the symbols are subjected to the drop display by moving the symbols downward within the symbol display frame 102.

Subsequently, the game progresses as in the above-mentioned case. That is, when each symbol subjected to the drop display is displayed as they are landing on a statically displayed symbol as indicated in the lower image display panel 6 shown on the right position on the 3rd stage in FIG. 14, each symbol is statically displayed in a symbol display area subjected to the landing display. However, here, even when each symbol subjected to the drop display is displayed as they are landing on the lower edge 102B of the symbol display frame 102, each symbol is statically displayed on the symbol display area subjected to the landing display.

At this time, when the symbols statically displayed in the symbol display areas are of the same display color (attribute) and in a state of neighboring with each other in any one of the four directions vertically and horizontally, all the symbols displayed in the symbol display areas neighboring with each other are treated as being in a connected state. The symbols being in the connected state are connectedly displayed by applying the texture mapping to backgrounds in the symbol display areas in which the symbols are displayed as indicated in the lower image display panel 6 shown at the right position on the 3rd stage in FIG. 14.

When each symbol connectedly displayed is in the state where four or more symbols are adjacent to each other, the outer frame 106 of a group formed by each symbol display area in which each symbol participating in the adjacency is displayed, is highlighted as indicated in the lower image display panel 6 shown at the right position on the 3rd stage in FIG. 14. Then, the elimination display of removing the outer frame 106 and each symbol in the outer frame 106 is performed as indicated in the lower image display panel 6 shown from the right position on the 3rd stage to the right position on the 4th stage in FIG. 14. A payout for the elimination display is provided at this time. In this regard, the amount of the provided payout becomes the amount obtained by multiplying the number of outer frames 106 subjected to the elimination display by the standard amount of payout. More specifically, there are two outer frames 106 subjected to the elimination display in the lower image display panel 6 shown from the right position on the 3rd stage to the right position on the 4th stage in FIG. 14. At this moment, since the standard amount of payout is “20”, a payout amounting to 2×“20”=“40” is provided, and a numeral obtained by adding “40” of the amount of payout to the current payout number is displayed in the payout number display part 9. When this payout is assigned, the standard amount of payout is further doubled.

Also subsequently, if there are symbols statically displayed in symbol display areas located above the symbol display areas subjected to the elimination display of symbols within the symbol display frame 102, the drop display of the symbols is performed by moving the symbols downward in the symbol display frame 102. Then, the game further progresses as shown in the above-mentioned case.

If there is no symbol statically displayed in the symbol display area located above the symbol display areas subjected to the elimination display of symbols within the symbol display frame 102 as indicated in the lower image display panel 6 shown at the left position on the 4th stage in FIG. 14, the unit game terminates at the time.

The row number of symbols (that is, the number of symbols) subjected to the drop display from the top edge 102A of the symbol display frame 102 at the time of starting the unit game is changed according to the BET number bet on the unit game. In the example shown in FIG. 14, the drop display of six symbols aligned in 5 rows by 1 column is performed from the top edge 102A of the symbol display frame 102 when the BET number is “1”.

That is, when the BET number is “1”, five symbols aligned in 5 rows by 1 column are subjected to the drop display from the upper edge 102A of the symbol display frame 102. FIG. 16 is a diagram showing an aligned state of symbols subjected to the drop display from the top edge 102A of the symbol display frame 102 at the time of the start of the unit game for which the BET number is set to “1.” As shown in FIG. 16, at the time of the start of the unit game for which the BET number is set to “1”, a group 107A of five symbols aligned in 5 rows by 1 column are subjected to the drop display from the top edge 102A of the symbol display frame 102.

When the BET number is “2”, nine symbols aligned in 5 rows by 2 columns are subjected to the drop display from the top edge 102A of the symbol display frame 102. FIG. 17 is a diagram showing an aligned state of symbols subjected to the drop display from the upper edge 102A of the symbol display frame 102 at the time of the start of the unit game for which the BET number is set to “2”. As shown in FIG. 17, at the time of the start of the unit game for which the BET number is set to “2”, a group 107B of nine symbols aligned in 5 rows by 2 columns are subjected to the drop display from the top edge 102A of the symbol display frame 102.

When the BET number is “3”, twelve symbols aligned in 5 rows by 3 columns are subjected to the drop display from the top edge 102A of the symbol display frame 102. FIG. 18 is a diagram showing an aligned state of symbols subjected to the drop display from the upper edge 102A of the symbol display frame 102 at the time of the start of the unit game for which the BET number is set to “3”. As shown in FIG. 18, at the time of the start of the unit game for which the BET number is set to “3”, a group 107C of twelve symbols aligned in 5 rows×3 columns are subjected to the falling display from the top edge 102A of the symbol display frame 102.

Since the configuration and the control of a slot machine in the case shown in FIG. 14 are the same as the configuration and the control of the slot machine 1 in the case shown in FIG. 1, the description is omitted.

The present invention can be applied to a display technique concerning the rearrangement of symbols in the slot machine.

Further, a gaming machine and a game system as described below may be provided in accordance with the present invention.

In a slot machine according to the present embodiment of the present invention, the game controller operates to cause the display to perform a variety of display of one symbol having one of the plurality of attributes in a plurality of symbol display areas arranged in a matrix manner in the display frame. At this moment, the game controller operates to cause the display to display statically a first predetermined number of symbols in a first corresponding number of symbol display areas forming a first predetermined range positioned on a bottom edge of the display frame at a beginning of a unit game. And the game controller operates to cause the display to perform a drop display of a second predetermined number of symbols in a second corresponding number of symbol display areas forming a second predetermined range positioned on a top edge of the display frame wherein the second predetermined number of symbols are moved downward from the top edge through empty symbol display areas positioned below the second predetermined range and above the first predetermined range.

The game controller operates to cause the display to display statically the second predetermined number of symbols in a third corresponding number of symbol display areas forming a third predetermined range after the second predetermined number of symbols are landed on the first predetermined range, which is located just above the third predetermined range. The game controller also operates to cause the display to display all symbols having a same attribute in a fourth corresponding number of symbol display areas, each of which neighbors on at least one of four directions: up and down and left and right, in a grouped manner. The game controller also operates to cause the display to perform an elimination display of all symbols appearing in the fourth corresponding number of symbol display areas if the fourth corresponding number is at least a predetermined number.

The game controller also operates to cause a payout corresponding to the elimination display.

In the slot machine as described above, the game controller operates to causes the display to display a dropping symbol in any one of display areas directly or indirectly above a display area from which a displayed symbol is removed by the elimination display in the display frame as the dropping symbol is moved downward through one or more empty symbol display areas until landing on an occupied symbol display area. The game controller operates to cause the display to perform again an elimination display of all symbols having a same attribute and appearing in a sixth corresponding number of symbol display areas which neighbors with each other on at least one of the four directions if the sixth corresponding number is at least the predetermined number; and provide a payout corresponding to a number of the elimination displays and an increased standard amount.

In the slot machine as described above, the game controller operates to cause the display to perform a drop display of the second predetermined number of symbols in the second corresponding number of symbol display areas arranged in a predetermined number of rows corresponding to the bet number in the display frame as the second predetermined number of symbols are moved downward from the top edge of the display frame through one of more empty symbol display areas.

In the slot machine as described above, the game controller operates to cause the display to perform a drop display of the second predetermined number of symbols in the second corresponding number of symbol display areas arranged in a predetermined number of columns corresponding to the bet number in the display frame as the second predetermined number of symbols are moved downward from the top edge of the display frame through one of more empty symbol display areas.

In a slot machine according to the present invention, a game controller operates to cause the display to display statically a first predetermined number of symbols in a first corresponding number of symbol display areas forming a first predetermined range positioned on a bottom edge of the display frame at a beginning of a unit game. The game controller also operates to cause the display to display a second plurality of symbols in a second corresponding number of symbol display areas arranged in a second predetermined number of rows in responsive to the bet number bet by the bet button wherein the second plurality of symbols are moved downward from the top edge toward the first predetermined range. The game controller further operates to cause the display to display statically the second predetermined number of symbols in a third corresponding number of symbol display areas forming a third predetermined range after the second predetermined number of symbols are landed on the first predetermined range, which is located just above the third predetermined range. The game controller operates to cause the display to display all symbols having a same attribute in a fourth corresponding number of symbol display areas, each of which neighbors on at least one of four directions: up and down and left and right, in a grouped manner. The game controller yet operates to cause the display to perform an elimination display of all symbols appearing in the fourth corresponding number of symbol display areas if the fourth corresponding number is at least a predetermined number. And the game controller operates to cause a payout corresponding to the elimination display. The game controller also operates to cause the display to display an upper symbol displayed in an upper symbol display area above a lower symbol display area in which a symbol is removed by the elimination display as the upper symbol is moved downward toward the lower symbol display area again. Then, the game controller operates to cause the display to perform an elimination display of all symbols having a same attribute and appearing in a sixth corresponding number of symbol display areas which neighbors with each other on at least one of the four directions if the sixth corresponding number is at least the predetermined number; and provide a payout corresponding to a number of the elimination displays and an increased standard amount.

In a slot machine comprising: a display which displays a plurality of symbols; a bet button; and a game controller. The game controller operates to cause the display to display statically a first predetermined number of symbols in a first corresponding number of symbol display areas forming a first predetermined range positioned on a bottom edge of the display frame at a beginning of a unit game. The game controller also operates to cause the display to display a second plurality of symbols in a second corresponding number of symbol display areas arranged in a second predetermined number of columns in responsive to the bet number bet by the bet button wherein the second plurality of symbols are moved downward from the top edge toward the first predetermined range. The game controller yet operates to cause the display to display statically the second predetermined number of symbols in a third corresponding number of symbol display areas forming a third predetermined range after the second predetermined number of symbols are landed on the first predetermined range, which is located just above the third predetermined range. The game controller further operates to cause the display to display all symbols having a same attribute in a fourth corresponding number of symbol display areas, each of which neighbors on at least one of four directions: up and down and left and right, in a grouped manner. The game controller operates to cause the display to perform an elimination display of all symbols appearing in the fourth corresponding number of symbol display areas if the fourth corresponding number is at least a predetermined number. The game controller also operates to cause a payout corresponding to the elimination display and provide a payout corresponding to a number of the elimination displays and an increased standard amount. The game controller operates to cause the display to display an upper symbol displayed in an upper symbol display area above a lower symbol display area in which a symbol is removed by the elimination display as the upper symbol is moved downward toward the lower symbol display area again. The game controller also operates to rearrange symbols displayed in a fifth corresponding number of symbol display areas in the display frame after a drop display is performed. The game controller also operates to cause the display to perform an elimination display of all symbols having a same attribute and appearing in a sixth corresponding number of symbol display areas which neighbors with each other on at least one of the four directions if the sixth corresponding number is at least the predetermined number.

In a method of playing a game with a slot machine comprising a display; a bet button; and a game controller, the game controller operates to repeat a unit game in which a changing way of displaying one symbol having one of a plurality of attributes in a plurality of symbol display areas arranged in a matrix manner in a display frame displayed on a display. The game controller operates to cause the display to display statically a plurality of symbols in a corresponding number of symbol display areas forming a predetermined range positioned on a bottom edge of the display frame in the display frame. The game controller operates to cause the display to perform a drop display of a predetermined number of symbols corresponding to the bet number to be moved downward from a top edge of the display frame toward the predetermined range. The game controller still operates to cause the display to display statically the predetermined number of symbols, which are moved downward and stopped on the predetermined range. The game controller operates to cause the display to perform a connected display of all symbols having a same attribute and neighboring with each other on at least one of four directions: up and down and left and right in a connected manner. The game controller operates to cause the display to perform an elimination display of the all symbols having a same attribute and neighboring with each other displayed in a corresponding number of symbol display areas if the corresponding number is at least a predetermined number. And the game controller provides a player with a payout corresponding to the elimination display.

In the method of playing the game with the slot machine as described above, wherein the game controller operates to causes the display to perform again a drop display of an upper symbol displayed statically in an upper symbol display area above a lower symbol display area in which the elimination display is performed in the display frame wherein the upper symbol is moved downward toward the lower symbol display area. The game controller operates to provide a player again with a payout corresponding to a number of elimination displays and an increased payout rate based on the repeated elimination displays in the unit game.

In the method of playing the game with the slot machine as described above, wherein the game controller operates to causing the display to perform a drop display of the plurality of symbols displayed in the symbol display areas arranged in a predetermined number of rows corresponding to the bet number set by the bet button wherein the plurality of symbols are moved downward from the top edge.

In the method of playing the game with the slot machine as described above, the game controller operates to cause the display to perform a drop display of the plurality of symbols displayed in the symbol display areas arranged in a predetermined number of columns corresponding to the bet number set by the bet button wherein the plurality of symbols are moved downward from the top edge.

In a method of playing a game with a slot machine comprising a display; a bet button; and a game controller, the game controller operates to repeat a unit game in which a changing way of displaying one symbol having one of a plurality of attributes in a plurality of symbol display areas arranged in a matrix manner in a display frame displayed on a display. In the method, a bet number is set for the unit game by a player with the bet button. The game controller operates to cause the display to display statically a plurality of symbols in a corresponding number of symbol display areas forming a predetermined range positioned on a bottom edge of the display frame in the display frame. The game controller also operates to cause the display to perform a drop display of a predetermined number of symbols arranged in a predetermined number of rows corresponding to the bet number to be moved downward from a top edge of the display frame toward the predetermined range. The game controller operates to cause the display to display statically the predetermined number of symbols, which are moved downward and stopped on the predetermined range. The game controller further operates to cause the display to perform a connected display of all symbols having a same attribute and neighboring with each other on at least one of four directions: up and down and left and right in a connected manner. The game controller yet operates to cause the display to perform an elimination display of the all symbols having a same attribute and neighboring with each other displayed in a corresponding number of symbol display areas if the corresponding number is at least a predetermined number. The game controller operates to provide a player with a payout corresponding to the elimination display and provide the player again with a payout corresponding to a number of elimination displays and an increased payout rate based on the repeated elimination displays in the unit game. The game controller operates to cause the display to perform again a drop display of an upper symbol displayed statically in an upper symbol display area above a lower symbol display area in which the elimination display of the symbol is performed in the display frame wherein the upper symbol is moved downward toward the lower symbol display area.

In a method of playing a game with a slot machine comprising a display; a bet button; and a game controller, the game controller operates to repeat a unit game in which a changing way of displaying one symbol having one of a plurality of attributes in a plurality of symbol display areas arranged in a matrix manner in a display frame displayed on a display. In the method, a bet number is set for the unit game by a player with the bet button. The game controller operates to cause the display to display statically a plurality of symbols in a corresponding number of symbol display areas forming a predetermined range positioned on a bottom edge of the display frame in the display frame. The game controller also operates to cause the display to perform a drop display of a predetermined number of symbols arranged in a predetermined number of columns corresponding to the bet number to be moved downward from a top edge of the display frame toward the predetermined range. The game controller operates to cause the display to display statically the predetermined number of symbols, which are moved downward and stopped on the predetermined range. The game controller further operates to cause the display to perform a connected display of all symbols having a same attribute and neighboring with each other on at least one of four directions: up and down and left and right in a connected manner. The game controller yet operates to cause the display to perform an elimination display of the all symbols having a same attribute and neighboring with each other displayed in a corresponding number of symbol display areas if the corresponding number is at least a predetermined number. The game controller operates to provide a player with a payout corresponding to the elimination display and provide the player again with a payout corresponding to a number of elimination displays and an increased payout rate based on the repeated elimination displays in the unit game. The game controller operates to cause the display to perform again a drop display of an upper symbol displayed statically in an upper symbol display area above a lower symbol display area in which the elimination display of the symbol is performed in the display frame wherein the upper symbol is moved downward toward the lower symbol display area.

Here, in the slot machine and the method of playing according to the present invention, when an elimination display of a predetermined number of symbols having the same attribute and being displayed in symbol display areas neighboring with each other is performed if the predetermined number is at least a predetermined number, a payout is provided to the player in accordance with the performed elimination display. Therefore, the slot machine may provide a new entertaining feature.

What is claimed is:

1. A slot machine comprising:
a display which displays a plurality of symbols, each of which has one of a plurality of attributes, in a predetermined number of symbol display areas arranged in a matrix manner to form a display frame, each symbol display area being capable of containing one symbol;
an input device by which a bet number is set for a unit game; and
a game controller which operates to:
cause the display to display statically a first predetermined number of symbols in a first corresponding number of symbol display areas forming a first predetermined range positioned on a bottom edge of the display frame at a beginning of a unit game;
cause the display to display a second predetermined number of symbols in a second corresponding number of symbol display areas forming a second predetermined range positioned on a top edge of the display frame wherein the second predetermined number of symbols are moved downward from the top edge through empty symbol display areas positioned below the second predetermined range and above the first predetermined range;
cause the display to display statically the second predetermined number of symbols in a third corresponding number of symbol display areas forming a third predetermined range after the second predetermined number of symbols are landed on the first predetermined range, which is located just above the third predetermined range;
cause the display to display all symbols having a same attribute in a fourth corresponding number of symbol display areas, each of which neighbors on at least one of four directions: up and down and left and right, in a grouped manner;
cause the display to perform an elimination display of all symbols appearing in the fourth corresponding number of symbol display areas if the fourth corresponding number is at least a predetermined number; and
cause a payout corresponding to the elimination display.

2. The slot machine according to claim 1,
wherein the game controller operates to cause the display to display a dropping symbol in any one of symbol display areas directly or indirectly above a symbol display area from which a displayed symbol is removed by the elimination display in the display frame as the dropping symbol is moved downward through one or more empty symbol display areas until landing on an occupied symbol display area; and
wherein the game controller operates to:
rearrange symbols displayed in a fifth corresponding number of symbol display areas in the display frame after a drop display is performed;
cause the display to perform another elimination display of all symbols having a same attribute and appearing in a sixth corresponding number of symbol display areas which neighbors with each other on at least one of the four directions if the sixth corresponding number is at least the predetermined number; and
provide a payout corresponding to a number of the elimination displays and an increased standard amount.

3. The slot machine according to claim 1,
wherein the game controller operates to cause the display to perform a drop display of the second predetermined number of symbols in the second corresponding number of symbol display areas arranged in a predetermined number of rows corresponding to the bet number in the display frame as the second predetermined number of symbols are moved downward from the top edge of the display frame through one or more empty symbol display areas.

4. The slot machine according to claim 1,
wherein the game controller operates to cause the display to perform a drop display of the second predetermined number of symbols in the second corresponding number of symbol display areas arranged in a predetermined number of columns corresponding to the bet number in the display frame as the second predetermined number of symbols are moved downward from the top edge of the display frame through one or more empty symbol display areas.

5. A slot machine comprising:
a display which displays a plurality of symbols, each of which has one of a plurality of attributes, in a predetermined number of symbol display areas arranged in a matrix manner to form a display frame, each symbol display area being capable of containing one symbol;
an input device by which a bet number is set for a unit game; and
a game controller which operates to:
cause the display to display statically a first predetermined number of symbols in a first corresponding number of symbol display areas forming a first predetermined range positioned on a bottom edge of the display frame at a beginning of a unit game;
cause the display to display a second plurality of symbols in a second corresponding number of symbol display areas arranged in a second predetermined number of rows corresponding to the bet number bet by the input device wherein the second plurality of symbols are moved downward from the top edge toward the first predetermined range;
cause the display to display statically the second predetermined number of symbols in a third corresponding number of symbol display areas forming a third predetermined range after the second predetermined number of symbols are landed on the first predetermined range, which is located just above the third predetermined range;
cause the display to display all symbols having a same attribute in a fourth corresponding number of symbol display areas, each of which neighbors on at least one of four directions: up and down and left and right, in a grouped manner;
cause the display to perform an elimination display of all symbols appearing in the fourth corresponding number of symbol display areas if the fourth corresponding number is at least a predetermined number;
cause a payout corresponding to the elimination display;
cause the display to display an upper symbol displayed in an upper symbol display area above a lower symbol display area in which a symbol is removed by the elimination display as the upper symbol is moved downward toward the lower symbol display area again;
rearrange symbols displayed in a fifth corresponding number of symbol display areas in the display frame after a drop display is performed;
cause the display to perform an elimination display of all symbols having a same attribute and appearing in a sixth corresponding number of symbol display areas which neighbors with each other on at least one of the four directions if the sixth corresponding number is at least the predetermined number; and
provide a payout corresponding to a number of the elimination displays and an increased standard amount.

6. A slot machine comprising:
a display which displays a plurality of symbols, each of which has one of a plurality of attributes, in a predetermined number of symbol display areas arranged in a matrix manner to form a display frame, each symbol display area being capable of containing one symbol;
an input device by which a bet number is set for a unit game; and
a game controller which operates to:
cause the display to display statically a first predetermined number of symbols in a first corresponding number of symbol display areas forming a first predetermined range positioned on a bottom edge of the display frame at a beginning of a unit game;
cause the display to display a second plurality of symbols in a second corresponding number of symbol display areas arranged in a second predetermined number of columns corresponding to the bet number bet by the input device wherein the second plurality of symbols are moved downward from the top edge toward the first predetermined range;
cause the display to display statically the second predetermined number of symbols in a third corresponding number of symbol display areas forming a third predetermined range after the second predetermined number of symbols are landed on the first predetermined range, which is located just above the third predetermined range;
cause the display to display all symbols having a same attribute in a fourth corresponding number of symbol display areas, each of which neighbors on at least one of four directions: up and down and left and right, in a grouped manner;
cause the display to perform an elimination display of all symbols appearing in the fourth corresponding number of symbol display areas if the fourth corresponding number is at least a predetermined number;
cause a payout corresponding to the elimination display;
cause the display to display an upper symbol displayed in an upper symbol display area above a lower symbol display area in which a symbol is removed by the elimination display as the upper symbol is moved downward toward the lower symbol display area again;
rearrange symbols displayed in a fifth corresponding number of symbol display areas in the display frame after a drop display is performed;
cause the display to perform an elimination display of all symbols having a same attribute and appearing in a sixth corresponding number of symbol display areas which neighbors with each other on at least one of the four directions if the sixth corresponding number is at least the predetermined number; and
provide a payout corresponding to a number of the elimination displays and an increased standard amount.

7. A method of playing a game with a slot machine comprising the steps of:
repeating a unit game in which a changing way of displaying one symbol having one of a plurality of attributes in a plurality of symbol display areas arranged in a matrix manner in a display frame displayed on a display;
setting a bet number for the unit game as a player operates an input device;
displaying statically a plurality of symbols in a corresponding number of symbol display areas forming a predetermined range positioned on a bottom edge of the display frame in the display frame;
performing a drop display of a predetermined number of symbols corresponding to the bet number to be moved downward from a top edge of the display frame toward the predetermined range;
displaying statically the predetermined number of symbols, which are moved downward and stopped on the predetermined range;
performing a connected display of all symbols having a same attribute and neighboring with each other on at least one of four directions: up and down and left and right in a connected manner;
performing an elimination display of the all symbols having a same attribute and neighboring with each other displayed in a corresponding number of symbol display areas if the corresponding number is at least a predetermined number; and
providing a player with a payout corresponding to the elimination display.

8. The method of playing the game with the slot machine according to claim 7 further comprising the steps of:
performing again a drop display of an upper symbol displayed statically in an upper symbol display area above a lower symbol display area in which the elimination display is performed in the display frame wherein the upper symbol is moved downward toward the lower symbol display area;
providing a player again with a payout corresponding to a number of elimination displays and an increased payout rate based on the repeated elimination displays in the unit game.

9. The method of playing the game with the slot machine according to claim 7 further comprising the step of:
performing a drop display of the plurality of symbols displayed in the symbol display areas arranged in a predetermined number of rows corresponding to the bet number set by the input device wherein the plurality of symbols are moved downward from the top edge.

10. The method of playing the game with the slot machine according to claim 7 further comprising the step of:
performing a drop display of the plurality of symbols displayed in the symbol display areas arranged in a predetermined number of columns corresponding to the bet number set by the input device wherein the plurality of symbols are moved downward from the top edge.

11. A method of playing a game with a slot machine comprising the steps of:
repeating a unit game in which a changing way of displaying one symbol having one of a plurality of attributes in a plurality of symbol display areas arranged in a matrix manner in a display frame displayed on a display;
setting a bet number for the unit game as a player operates an input device;
displaying statically a plurality of symbols in a corresponding number of symbol display areas forming a predetermined range positioned on a bottom edge of the display frame in the display frame;
performing a drop display of a predetermined number of symbols arranged in a predetermined number of rows corresponding to the bet number to be moved downward from a top edge of the display frame toward the predetermined range;
displaying statically the predetermined number of symbols, which are moved downward and stopped on the predetermined range;
performing a connected display of all symbols having a same attribute and neighboring with each other on at least one of four directions: up and down and left and right in a connected manner;
performing an elimination display of the all symbols having a same attribute and neighboring with each other displayed in a corresponding number of symbol display areas if the corresponding number is at least a predetermined number; and
providing a player with a payout corresponding to the elimination display;
performing again a drop display of an upper symbol displayed statically in an upper symbol display area above a lower symbol display area in which the elimination display of the symbol is performed in the display frame wherein the upper symbol is moved downward toward the lower symbol display area; and
providing a player again with a payout corresponding to a number of elimination displays and an increased payout rate based on the repeated elimination displays in the unit game.

12. A method of playing a game with a slot machine comprising the steps of:
repeating a unit game in which a changing way of displaying one symbol having one of a plurality of attributes in a plurality of symbol display areas arranged in a matrix manner in a display frame displayed on a display;
setting a bet number for the unit game as a player operates an input device;
displaying statically a plurality of symbols in a corresponding number of symbol display areas forming a predetermined range positioned on a bottom edge of the display frame in the display frame;
performing a drop display of a predetermined number of symbols arranged in a predetermined number of columns corresponding to the bet number to be moved downward from a top edge of the display frame toward the predetermined range;
displaying statically the predetermined number of symbols, which are moved downward and stopped on the predetermined range;
performing a connected display of all symbols having a same attribute and neighboring with each other on at least one of four directions: up and down and left and right in a connected manner;
performing an elimination display of the all symbols having a same attribute and neighboring with each other displayed in a corresponding number of symbol display areas if the corresponding number is at least a predetermined number; and
providing a player with a payout corresponding to the elimination display;
performing again a drop display of an upper symbol displayed statically in an upper symbol display area above a lower symbol display area in which the elimination display of the symbol is performed in the display frame wherein the upper symbol is moved downward toward the lower symbol display area; and
providing a player again with a payout corresponding to a number of elimination displays and an increased payout rate based on the repeated elimination displays in the unit game.
